(19) United States
(12) Patent Application Publication
(10) Pub. No.: US 2026/0289768 A1
(43) Pub. Date: Sep. 24, 2026

(54) NEURAL NETWORK BASED AUTOMATIC IMAGE SEGMENTATION SYSTEM AND ITS OPERATION METHOD AND NON-TRANSITORY COMPUTER READABLE MEDIUM

(71) Applicants: Taipei Medical University (TMU), Taipei City (TW); TAIPEI VETERANS GENERAL HOSPITAL, TAIPEI CITY (TW)

(72) Inventors: Syu-Jyun PENG, Hsinchu County (TW); Huai-Che YANG, Taipei City (TW); Chi-Jen CHOU, Kaohsiung City (TW); Chun-Chun HUANG, Hsinchu County (TW)

(21) Appl. No.: 19/315,851

(22) Filed: Sep. 2, 2025

(30) Foreign Application Priority Data
Mar. 20, 2025 (TW) 114110462

(51) Int. Cl. G06T 7/00; G06T 7/11; G06V 10/24; G06V 10/26; G06V 10/44; G06V 10/764; G06V 10/82; G06V 20/64

(52) U.S. Cl. CPC G06T 7/0012; G06T 7/11; G06V 10/242; G06V 10/273; G06V 10/443; G06V 10/764; G06V 10/82; G06V 20/647; G06T 2207/20084; G06T 2207/30016; G06V 2201/031

(57) ABSTRACT

The present disclosure provides an operation method of a neural network based automatic image segmentation system, which includes the following steps. A plurality of two-dimensional brain parenchyma images of the brain are extracted from a plurality of T2-weighted images of the brain through a two-dimensional neural network, and the plurality of two-dimensional brain parenchyma images of the brain constitute a three-dimensional brain parenchyma image of the brain; the three-dimensional brain parenchyma image of the brain is pre-processed to obtain a pre-processed three-dimensional brain parenchyma image; and at least one cerebral cavernous malformation image is segmented from the pre-processed three-dimensional brain parenchyma image through a three-dimensional convolutional neural network.

### CROSS - REFERENCE TO RELATED APPLICATION

This application claims priority to Taiwan Application Serial Number 114110462, filed Mar. 20, 2025, which is herein incorporated by reference.

### BACKGROUND

### Field of Invention

The present invention relates to computer systems and operation methods, neural network based automatic image segmentation systems and operation methods thereof.

### Description of Related Art

The cerebral cavernous malformation (CCM) is a disease in which the cerebral blood vessels are structurally abnormal. CCMs are distinguished by recurrent variable hemorrhaging and hemosiderin deposition, both of which can make it difficult to define the true edge of a CCM based solely on the traditional imaging detection.

In view of the foregoing, there still exist some problems on the traditional imaging detection that await further improvement. However, those skilled in the art sought vainly for a solution. Accordingly, there is an urgent need in the related field to automatically segment the cerebral cavernous malformation image more accurately.

### SUMMARY

In one or more various aspects, the present disclosure is directed to neural network based automatic image segmentation systems and operation methods thereof.

An embodiment of the present disclosure is related to a neural network based automatic image segmentation system. The neural network based automatic image segmentation system includes a storage device and a processor. The storage device is configured to store at least one instruction. The processor is coupled to the storage device, and the processor is configured to access and execute the at least one instruction for: extracting a plurality of two-dimensional brain parenchyma images of a brain from a plurality of T2-weighted images of the brain through a two-dimensional neural network, where the plurality of the two-dimensional brain parenchyma images of the brain constitute a three-dimensional brain parenchyma image of the brain; performing a pre-process on the three-dimensional brain parenchyma image of the brain to obtain a pre-processed three-dimensional brain parenchyma image; and segmenting at least one cerebral cavernous malformation image from the pre-processed three-dimensional brain parenchyma image through a three-dimensional convolutional neural network.

In one embodiment of the present disclosure, the two-dimensional neural network is a mask region-based convolutional neural network, and the mask region-based convolutional neural network removes signals related to a skull and a scalp to extract the plurality of the two-dimensional brain parenchyma images of the brain.

In one embodiment of the present disclosure, the pre-process performed by the processor includes: performing a resampling on the three-dimensional brain parenchyma image of the brain, where the resampling scales each voxel in the three-dimensional brain parenchyma image of the brain from an initial size to a predetermined size to obtain a resampled three-dimensional brain parenchyma image; and using a Z-score intensity normalization to standardize a grayscale intensity of each data point in the resampled three-dimensional brain parenchyma image to obtain a grayscale intensity standardized three-dimensional brain parenchyma image.

In one embodiment of the present disclosure, the pre-process performed by the processor further includes: performing a data augmentation on the grayscale intensity standardized three-dimensional brain parenchyma image, where the data augmentation generates additional images based on a random rotation and a random scaling for the grayscale intensity standardized three-dimensional brain parenchyma image, and the grayscale intensity standardized three-dimensional brain parenchyma image and the additional images serve as the pre-processed three-dimensional brain parenchyma image.

In one embodiment of the present disclosure, the processor accesses and executes the at least one instruction for: extracting first-scale image patches from the pre-processed three-dimensional brain parenchyma image through a first channel of the three-dimensional convolutional neural network, extracting second-scale image patches from the pre-processed three-dimensional brain parenchyma image through a second channel of the three-dimensional convolutional neural network, where a resolution of the second-scale image patches is different from a resolution of the first-scale image patches; and after the first-scale image patches of the first channel and the second-scale image patches of the second channel complete a convolutional processing in fully convolutional layers of the three-dimensional convolutional neural network, performing an up-sampling on the second channel to facilitate a processing in fully connected layers of the three-dimensional convolutional neural network for an information matching and a classification, and then a classification layer of the three-dimensional convolutional neural network outputs a segmentation result of the at least one cerebral cavernous malformation image.

Another embodiment of the present disclosure is related to an operation method of a neural network based automatic image segmentation system. The operation method includes steps of: (A) extracting a plurality of two-dimensional brain parenchyma images of a brain from a plurality of T2-weighted images of the brain through a two-dimensional neural network, where the plurality of the two-dimensional brain parenchyma images of the brain constitute a three-dimensional brain parenchyma image of the brain; (B) performing a pre-process on the three-dimensional brain parenchyma image of the brain to obtain a pre-processed three-dimensional brain parenchyma image; and (C) segmenting at least one cerebral cavernous malformation image from the pre-processed three-dimensional brain parenchyma image through a three-dimensional convolutional neural network.

In one embodiment of the present disclosure, the two-dimensional neural network is a mask region-based convolutional neural network, and the step (A) includes: removing signals related to a skull and a scalp through the mask region-based convolutional neural network to extract the plurality of the two-dimensional brain parenchyma images of the brain.

In one embodiment of the present disclosure, the step (B) includes: performing a resampling on the three-dimensional brain parenchyma image of the brain, where the resampling scales each voxel in the three-dimensional brain parenchyma image of the brain from an initial size to a predetermined size to obtain a resampled three-dimensional brain parenchyma image; and using a Z-score intensity normalization to standardize a grayscale intensity of each data point in the resampled three-dimensional brain parenchyma image to obtain a grayscale intensity standardized three-dimensional brain parenchyma image.

In one embodiment of the present disclosure, the step (B) includes: performing a data augmentation on the grayscale intensity standardized three-dimensional brain parenchyma image, where the data augmentation generates additional images based on a random rotation and a random scaling for the grayscale intensity standardized three-dimensional brain parenchyma image, and the grayscale intensity standardized three-dimensional brain parenchyma image and the additional images serve as the pre-processed three-dimensional brain parenchyma image.

In one embodiment of the present disclosure, the step (C) includes: extracting first-scale image patches from the pre-processed three-dimensional brain parenchyma image through a first channel of the three-dimensional convolutional neural network, extracting second-scale image patches from the pre-processed three-dimensional brain parenchyma image through a second channel of the three-dimensional convolutional neural network, where a resolution of the second-scale image patches is different from a resolution of the first-scale image patches; and after the first-scale image patches of the first channel and the second-scale image patches of the second channel complete a convolutional processing in fully convolutional layers of the three-dimensional convolutional neural network, performing an up-sampling on the second channel to facilitate a processing in fully connected layers of the three-dimensional convolutional neural network for an information matching and a classification, and then a classification layer of the three-dimensional convolutional neural network outputs a segmentation result of the at least one cerebral cavernous malformation image.

Technical advantages are generally achieved, by embodiments of the present disclosure. The neural network based automatic image segmentation system and its operation method can automatically segment the cerebral cavernous malformation image more accurately, so as to facilitate the process of CCM delineation in Gamma Knife (GK) radiosurgery and related clinical research.

Many of the attendant features will be more readily appreciated, as the same becomes better understood by reference to the following detailed description considered in connection with the accompanying drawings.

### BRIEF DESCRIPTION OF THE DRAWINGS

The invention can be more fully understood by reading the following detailed description of the embodiment, with reference made to the accompanying drawings as follows:

FIG. 1 is a block diagram of a neural network based automatic image segmentation system according to one embodiment of the present disclosure; and

FIG. 2 is a flow chart of an operation method of the neural network based automatic image segmentation system according to one embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

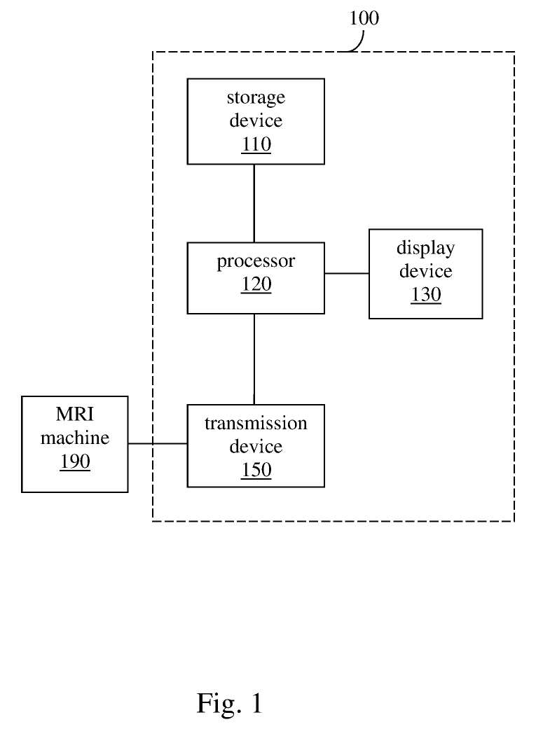

Referring to FIG. 1, in one aspect, the present disclosure is directed to a neural network based automatic image segmentation system 100. The neural network based automatic image segmentation system 100 may be easily used in a computer and may be applicable or readily adaptable to all technologies. Technical advantages are generally achieved by the neural network based automatic image segmentation system 100 according to embodiments of the present disclosure. Herewith the neural network based automatic image segmentation system 100 is described below with FIG. 1.

The subject disclosure provides the neural network based automatic image segmentation system 100 in accordance with the subject technology. Various aspects of the present technology are described with reference to the drawings. In the following description, for purposes of explanation, numerous specific details are set forth in order to provide a thorough understanding of one or more aspects. It can be evident, however, that the present technology can be practiced without these specific details. In other instances, well-known structures and devices are shown in block diagram form in order to facilitate describing these aspects. The word “exemplary” is used herein to mean “serving as an example, instance, or illustration.” Any embodiment described herein as “exemplary” is not necessarily to be construed as preferred or advantageous over other embodiments.

In practice, for example, the neural network based automatic image segmentation system 100 can be a computer server. The computer server can be remotely managed in a manner that substantially provides accessibility, consistency, and efficiency. Remote management removes the need for input/output interfaces in the servers. An administrator can manage a large data centers containing numerous rack servers using a variety of remote management tools, such as simple terminal connections, remote desktop applications, and software tools used to configure, monitor, and troubleshoot server hardware and software.

As used herein, “around”, “about”, “substantially” or “approximately” shall generally mean within 20 percent, preferably within 10 percent, and more preferably within 5 percent of a given value or range. Numerical quantities given herein are approximate, meaning that the term “around”, “about”, “substantially” or “approximately” can be inferred if not expressly stated.

In practice, in an embodiment of the present disclosure, the neural network based automatic image segmentation system 100 can selectively establish a connection with the MRI (Magnetic Resonance Imaging) machine 190. It should be understood that in the embodiments and the scope of the patent application, the description involving "connection" can generally refer to a component that indirectly communicates with another component by wired and/or wireless communication through another component, or a component that is physically connected to another element without through another element. For example, the neural network based automatic image segmentation system 100 can indirectly communicate with the MRI machine 190 through wired and/or wireless communication via another component, or the neural network based automatic image segmentation system 100 can be physically connected to the MRI machine 190 without another component. Those with ordinary skill in the art may select the connection manner depending on the desired application.

FIG. 1 is a block diagram of the neural network based automatic image segmentation system 100 according to one embodiment of the present disclosure. As shown in FIG. 1, the neural network based automatic image segmentation system 100 includes a storage device 110, a processor 120, a transmission device 150 and a display device 130. For example, the storage device 110 can be a hard drive, a flash memory or another storage device, the processor 120 can be a central processing unit, the display device 130 can be a built-in display or an external screen, and the transmission device 150 can be a connector, a wired and/or wireless network device or another transmission interface.

In structure, the neural network based automatic image segmentation system 100 is electrically connected to the MRI machine 190, the storage device 110 is electrically connected to the processor 120, the processor 120 is electrically connected to the display device 130, and the transmission device 150 is electrically connected to the processor 120. It should be noted that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. For example, the storage device 110 may be a built-in storage device that is directly connected to the processor 120, or the storage device 110 may be an external storage device that is indirectly connected to the processor 120 through the network device.

In practice, for example, the MRI machine 190 can scan a plurality of T2-weighted images of a brain. Although only one MRI machine 190 is shown in FIG. 1, this does not limit the present disclosure. In practice, the MRI machine 190 can generally refer to one or more MRI machines. Those skilled in the art can flexibly choose one or more MRI machine devices.

In some embodiments of the present disclosure, the storage device 110 stores the plurality of the T2-weighted images of a brain and at least one instruction, and the processor 120 is configured to access and execute the at least one instruction for: extracting a plurality of two-dimensional brain parenchyma images of the brain from the plurality of the T2-weighted images of the brain through a two-dimensional neural network, where the plurality of the two-dimensional brain parenchyma images of the brain constitute a three-dimensional brain parenchyma image of the brain; performing a pre-process on the three-dimensional brain parenchyma image of the brain to obtain a pre-processed three-dimensional brain parenchyma image; and segmenting at least one cerebral cavernous malformation image from the pre-processed three-dimensional brain parenchyma image through a three-dimensional convolutional neural network. In this way, the neural network based automatic image segmentation system 100 can automatically segment the cerebral cavernous malformation image more accurately, so as to facilitate the process of CCM delineation in GK radiosurgery and related clinical research.

It should be noted that CCMs are distinguished by recurrent variable hemorrhaging and hemosiderin deposition, both of which can make it difficult to define the true edge of a CCM based solely on other images (e.g., T1 images, general T2 images, etc.). Compared with the above-mentioned other images, In some embodiments of the present disclosure, the processor 120 uses the T2-weighted images to facilitate the three-dimensional convolutional neural network to accurately define the true edge of the cerebral cavernous malformation.

Regarding the specific mechanism of the two-dimensional neural network, in some embodiments of the present disclosure, the two-dimensional neural network is a mask region-based convolutional neural network, and the mask region-based convolutional neural network removes signals related to a skull and a scalp to extract the plurality of the two-dimensional brain parenchyma images of the brain, so as to improve the accuracy of the three-dimensional convolutional neural network in segmenting the cerebral cavernous malformation image.

Regarding the specific mechanism of the pre-processing described above, in some embodiments of the present disclosure, the pre-process performed by the processor 120 includes: performing a resampling on the three-dimensional brain parenchyma image of the brain, where the resampling scales each voxel in the three-dimensional brain parenchyma image of the brain from an initial size (e.g., 0.508 x 0.508 x 3.01 mm³) to a predetermined size (e.g., 1 x 1 x 1 mm³) to obtain a resampled three-dimensional brain parenchyma image, so as to improve the accuracy of the three-dimensional convolutional neural network in segmenting the cerebral cavernous malformation image; and using a Z-score intensity normalization to standardize a grayscale intensity of each data point in the resampled three-dimensional brain parenchyma image to obtain a grayscale intensity standardized three-dimensional brain parenchyma image, so as to improve the accuracy of the three-dimensional convolutional neural network in segmenting the cerebral cavernous malformation image.

Moreover, regarding the specific mechanism of the pre-processing described above, in some embodiments of the present disclosure, the pre-process performed by the processor 120 includes: performing a data augmentation on the grayscale intensity standardized three-dimensional brain parenchyma image, so as to enhance the segmentation ability of the cerebral cavernous malformation image of the three-dimensional convolutional neural network and to prevent overfitting. The data augmentation generates additional images based on a random rotation (e.g., random rotations along the X, Y, and Z axes from -45 to 45 degrees) and a random scaling (e.g., random scaling from 0.9 to 1.1 times) for the grayscale intensity standardized three-dimensional brain parenchyma image. The grayscale intensity standardized three-dimensional brain parenchyma image and the additional images serve as the pre-processed three-dimensional brain parenchyma image.

Regarding the specific mechanism of the three-dimensional convolutional neural network described above, in some embodiments of the present disclosure, the processor 120 accesses and executes the at least one instruction for: extracting first-scale image patches from the pre-processed three-dimensional brain parenchyma image through a first channel of the three-dimensional convolutional neural network (e.g., a DeepMedic model), extracting second-scale image patches from the pre-processed three-dimensional brain parenchyma image through a second channel of the three-dimensional convolutional neural network, where a resolution (e.g., a low resolution) of the second-scale image patches is different from a resolution (e.g., a standard resolution) of the first-scale image patches. In practice, for example, the first channel extracts normal-scale image patches with the standard resolution (to capture features in detail), and the second channel extracts large-scale image patches with the low resolution (to capture spatial positional information). Utilizing separate channels for the extraction of image feature patches at multiple resolutions enhances the ability of the three-dimensional convolutional neural network to learn to recognize the cerebral cavernous malformation images of various sizes in various brain locations.

Then, the processor 120 accesses and executes the at least one instruction for: after the first-scale image patches of the first channel and the second-scale image patches of the second channel complete a convolutional processing in fully convolutional layers of the three-dimensional convolutional neural network, performing an up-sampling (e.g., interpolation or other methods) on the second channel to facilitate a processing in fully connected layers of the three-dimensional convolutional neural network for an information matching and a classification, and then a classification layer (e.g., a final classification layer) of the three-dimensional convolutional neural network outputs a segmentation result of the at least one cerebral cavernous malformation image.

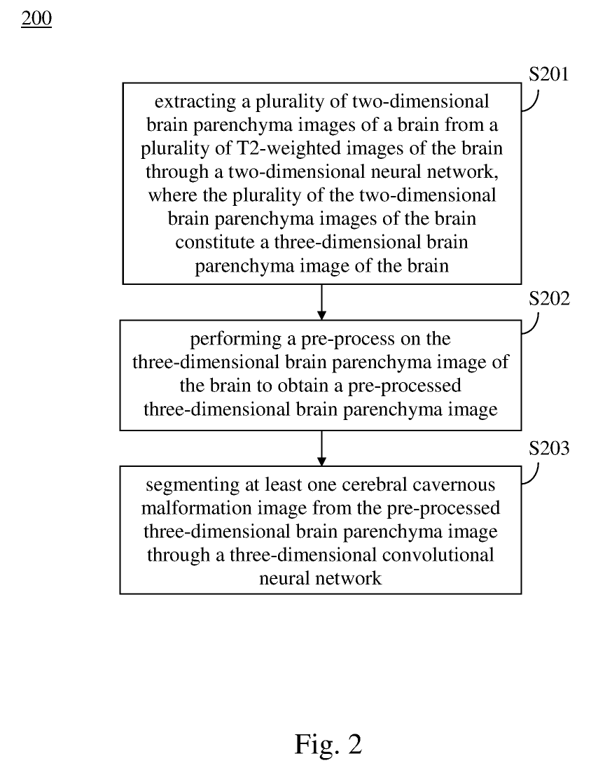

For a more complete understanding of an operation method of the neural network based automatic image segmentation system 100, referring FIGS. 1-2, FIG. 2 is a flow chart of the operation method 200 of the neural network based automatic image segmentation system 100 according to one embodiment of the present disclosure. As shown in FIG. 2, the operation method 200 includes operations S201-S203. However, as could be appreciated by persons having ordinary skill in the art, for the steps described in the present embodiment, the sequence in which these steps are performed, unless explicitly stated otherwise, can be altered depending on actual needs; in certain cases, all or some of these steps can be performed concurrently.

The operation method 200 may take the form of a computer program product on a computer-readable storage medium having computer-readable instructions embodied in the medium. Any suitable storage medium may be used including non-volatile memory such as read only memory (ROM), programmable read only memory (PROM), erasable programmable read only memory (EPROM), and electrically erasable programmable read only memory (EEPROM) devices; volatile memory such as SRAM, DRAM, and DDR-RAM; optical storage devices such as CD-ROMs and DVD-ROMs; and magnetic storage devices such as hard disk drives and floppy disk drives.

In some embodiments of the present disclosure, in step S201, a plurality of two-dimensional brain parenchyma images of the brain are extracted from a plurality of T2-weighted images of the brain through a two-dimensional neural network, and the plurality of two-dimensional brain parenchyma images of the brain constitute a three-dimensional brain parenchyma image of the brain. In step S202, the three-dimensional brain parenchyma image of the brain is pre-processed to obtain a pre-processed three-dimensional brain parenchyma image. In step S203, at least one cerebral cavernous malformation image is segmented from the pre-processed three-dimensional brain parenchyma image through a three-dimensional convolutional neural network.

In one embodiment of the present disclosure, the two-dimensional neural network is a mask region-based convolutional neural network, and step S201 includes: removing signals related to a skull and a scalp through the mask region-based convolutional neural network to extract the plurality of the two-dimensional brain parenchyma images of the brain.

In one embodiment of the present disclosure, step S202 includes: performing a resampling on the three-dimensional brain parenchyma image of the brain, where the resampling scales each voxel in the three-dimensional brain parenchyma image of the brain from an initial size to a predetermined size to obtain a resampled three-dimensional brain parenchyma image; and using a Z-score intensity normalization to standardize a grayscale intensity of each data point in the resampled three-dimensional brain parenchyma image to obtain a grayscale intensity standardized three-dimensional brain parenchyma image.

In one embodiment of the present disclosure, step S202 includes: performing a data augmentation on the grayscale intensity standardized three-dimensional brain parenchyma image, where the data augmentation generates additional images based on a random rotation and a random scaling for the grayscale intensity standardized three-dimensional brain parenchyma image, and the grayscale intensity standardized three-dimensional brain parenchyma image and the additional images serve as the pre-processed three-dimensional brain parenchyma image.

In one embodiment of the present disclosure, step S203 includes: extracting first-scale image patches from the pre-processed three-dimensional brain parenchyma image through a first channel of the three-dimensional convolutional neural network, extracting second-scale image patches from the pre-processed three-dimensional brain parenchyma image through a second channel of the three-dimensional convolutional neural network, where a resolution of the second-scale image patches is different from a resolution of the first-scale image patches; and after the first-scale image patches of the first channel and the second-scale image patches of the second channel complete a convolutional processing in fully convolutional layers of the three-dimensional convolutional neural network, performing an up-sampling on the second channel to facilitate a processing in fully connected layers of the three-dimensional convolutional neural network for an information matching and a classification, and then a classification layer of the three-dimensional convolutional neural network outputs a segmentation result of the at least one cerebral cavernous malformation image.

In view of the above, technical advantages are generally achieved, by embodiments of the present disclosure. The neural network based automatic image segmentation system 100 and its operation method 200 can automatically segment the cerebral cavernous malformation image more accurately, so as to facilitate the process of CCM delineation in GK radiosurgery and related clinical research.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A neural network based automatic image segmentation system, comprising:
a storage device configured to store at least one instruction; and
a processor coupled to the storage device, and the processor configured to access and execute the at least one instruction for:
extracting a plurality of two-dimensional brain parenchyma images of a brain from a plurality of T2-weighted images of the brain through a two-dimensional neural network, wherein the plurality of the two-dimensional brain parenchyma images of the brain constitute a three-dimensional brain parenchyma image of the brain;
performing a pre-process on the three-dimensional brain parenchyma image of the brain to obtain a pre-processed three-dimensional brain parenchyma image; and
segmenting at least one cerebral cavernous malformation image from the pre-processed three-dimensional brain parenchyma image through a three-dimensional convolutional neural network.

2. The neural network based automatic image segmentation system of claim 1, wherein the two-dimensional neural network is a mask region-based convolutional neural network, and the mask region-based convolutional neural network removes signals related to a skull and a scalp to extract the plurality of the two-dimensional brain parenchyma images of the brain.

3. The neural network based automatic image segmentation system of claim 1, wherein the pre-process performed by the processor comprises:
performing a resampling on the three-dimensional brain parenchyma image of the brain, wherein the resampling scales each voxel in the three-dimensional brain parenchyma image of the brain from an initial size to a predetermined size to obtain a resampled three-dimensional brain parenchyma image; and
using a Z-score intensity normalization to standardize a grayscale intensity of each data point in the resampled three-dimensional brain parenchyma image to obtain a grayscale intensity standardized three-dimensional brain parenchyma image.

4. The neural network based automatic image segmentation system of claim 3, wherein the pre-process performed by the processor further comprises:
performing a data augmentation on the grayscale intensity standardized three-dimensional brain parenchyma image, wherein the data augmentation generates additional images based on a random rotation and a random scaling for the grayscale intensity standardized three-dimensional brain parenchyma image, and the grayscale intensity standardized three-dimensional brain parenchyma image and the additional images serve as the pre-processed three-dimensional brain parenchyma image.

5. The neural network based automatic image segmentation system of claim 1, wherein the processor accesses and executes the at least one instruction for:
extracting first-scale image patches from the pre-processed three-dimensional brain parenchyma image through a first channel of the three-dimensional convolutional neural network, extracting second-scale image patches from the pre-processed three-dimensional brain parenchyma image through a second channel of the three-dimensional convolutional neural network, wherein a resolution of the second-scale image patches is different from a resolution of the first-scale image patches; and
after the first-scale image patches of the first channel and the second-scale image patches of the second channel complete a convolutional processing in fully convolutional layers of the three-dimensional convolutional neural network, performing an up-sampling on the second channel to facilitate a processing in fully connected layers of the three-dimensional convolutional neural network for an information matching and a classification, and then a classification layer of the three-dimensional convolutional neural network outputs a segmentation result of the at least one cerebral cavernous malformation image.

6. An operation method of a neural network based automatic image segmentation system, and the operation method, comprising steps of:
(A) extracting a plurality of two-dimensional brain parenchyma images of a brain from a plurality of T2-weighted images of the brain through a two-dimensional neural network, wherein the plurality of the two-dimensional brain parenchyma images of the brain constitute a three-dimensional brain parenchyma image of the brain;
(B) performing a pre-process on the three-dimensional brain parenchyma image of the brain to obtain a pre-processed three-dimensional brain parenchyma image; and
(C) segmenting at least one cerebral cavernous malformation image from the pre-processed three-dimensional brain parenchyma image through a three-dimensional convolutional neural network.

7. The operation method of claim 6, wherein the two-dimensional neural network is a mask region-based convolutional neural network, and the step (A) comprises:
removing signals related to a skull and a scalp through the mask region-based convolutional neural network to extract the plurality of the two-dimensional brain parenchyma images of the brain.

8. The operation method of claim 6, wherein the step (B) comprises:
performing a resampling on the three-dimensional brain parenchyma image of the brain, wherein the resampling scales each voxel in the three-dimensional brain parenchyma image of the brain from an initial size to a predetermined size to obtain a resampled three-dimensional brain parenchyma image; and
using a Z-score intensity normalization to standardize a grayscale intensity of each data point in the resampled three-dimensional brain parenchyma image to obtain a grayscale intensity standardized three-dimensional brain parenchyma image.

9. The operation method of claim 8, wherein the step (B) comprises:
performing a data augmentation on the grayscale intensity standardized three-dimensional brain parenchyma image, wherein the data augmentation generates additional images based on a random rotation and a random scaling for the grayscale intensity standardized three-dimensional brain parenchyma image, and the grayscale intensity standardized three-dimensional brain parenchyma image and the additional images serve as the pre-processed three-dimensional brain parenchyma image.

10. The operation method of claim 6, wherein the step (C) comprises:
extracting first-scale image patches from the pre-processed three-dimensional brain parenchyma image through a first channel of the three-dimensional convolutional neural network, extracting second-scale image patches from the pre-processed three-dimensional brain parenchyma image through a second channel of the three-dimensional convolutional neural network, wherein a resolution of the second-scale image patches is different from a resolution of the first-scale image patches; and
after the first-scale image patches of the first channel and the second-scale image patches of the second channel complete a convolutional processing in fully convolutional layers of the three-dimensional convolutional neural network, performing an up-sampling on the second channel to facilitate a processing in fully connected layers of the three-dimensional convolutional neural network for an information matching and a classification, and then a classification layer of the three-dimensional convolutional neural network outputs a segmentation result of the at least one cerebral cavernous malformation image.

11. A non-transitory computer readable medium to store a plurality of instructions for commanding a computer to execute an operation method, and the operation method comprising steps of:
(A) extracting a plurality of two-dimensional brain parenchyma images of a brain from a plurality of T2-weighted images of the brain through a two-dimensional neural network, wherein the plurality of the two-dimensional brain parenchyma images of the brain constitute a three-dimensional brain parenchyma image of the brain;
(B) performing a pre-process on the three-dimensional brain parenchyma image of the brain to obtain a pre-processed three-dimensional brain parenchyma image; and
(C) segmenting at least one cerebral cavernous malformation image from the pre-processed three-dimensional brain parenchyma image through a three-dimensional convolutional neural network.

12. The non-transitory computer readable medium of claim 11, wherein the two-dimensional neural network is a mask region-based convolutional neural network, and the step (A) comprises:
removing signals related to a skull and a scalp through the mask region-based convolutional neural network to extract the plurality of the two-dimensional brain parenchyma images of the brain.

13. The non-transitory computer readable medium of claim 11, wherein the step (B) comprises:
performing a resampling on the three-dimensional brain parenchyma image of the brain, wherein the resampling scales each voxel in the three-dimensional brain parenchyma image of the brain from an initial size to a predetermined size to obtain a resampled three-dimensional brain parenchyma image; and
using a Z-score intensity normalization to standardize a grayscale intensity of each data point in the resampled three-dimensional brain parenchyma image to obtain a grayscale intensity standardized three-dimensional brain parenchyma image.

14. The non-transitory computer readable medium of claim 13, wherein the step (B) comprises:
performing a data augmentation on the grayscale intensity standardized three-dimensional brain parenchyma image, wherein the data augmentation generates additional images based on a random rotation and a random scaling for the grayscale intensity standardized three-dimensional brain parenchyma image, and the grayscale intensity standardized three-dimensional brain parenchyma image and the additional images serve as the pre-processed three-dimensional brain parenchyma image.

15. The non-transitory computer readable medium of claim 11, wherein the step (C) comprises:
extracting first-scale image patches from the pre-processed three-dimensional brain parenchyma image through a first channel of the three-dimensional convolutional neural network, extracting second-scale image patches from the pre-processed three-dimensional brain parenchyma image through a second channel of the three-dimensional convolutional neural network, wherein a resolution of the second-scale image patches is different from a resolution of the first-scale image patches; and
after the first-scale image patches of the first channel and the second-scale image patches of the second channel complete a convolutional processing in fully convolutional layers of the three-dimensional convolutional neural network, performing an up-sampling on the second channel to facilitate a processing in fully connected layers of the three-dimensional convolutional neural network for an information matching and a classification, and then a classification layer of the three-dimensional convolutional neural network outputs a segmentation result of the at least one cerebral cavernous malformation image.
